(19) United States
(12) Patent Application Publication
(10) Pub. No.: US 2010/0090795 A1
(43) Pub. Date: Apr. 15, 2010

(54) Method for the wear-minimized operation of installation components

(76) Inventors: Herbert Grieb, Malsch (DE); Peter Müller, Karlsruhe (DE); Bernd-Markus Pfeiffer, Worth (DE); Robert Schwab, Karlsruhe (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/311,268

(22) PCT Filed: Sep. 28, 2006
(86) PCT No.: PCT/DE2006/001712

§ 371 Date: Dec. 9, 2009

(51) Int. Cl. G05B 23/02

(52) U.S. Cl. 340/3.42

(57) ABSTRACT

A method for wear-minimized operation of a component of an installation and a corresponding installation are disclosed. A sensor for state identification is associated with the component and transmits a sensor signal to an evaluation unit. The evaluation unit checks the sensor signal to ascertain whether a wear-promoting operating state is present, and in the event of the presence of such an operating state the component is driven such that a change in the operating state in favor of an operating state with less wear takes place. If, for example, a component is operated at its resonant frequency, it is ensured that the component is operated at a slightly different rotation speed, at which far less severe oscillations occur.

### CROSS REFERENCE TO RELATED APPLICATIONS

This application is the US National Stage of International Application No. PCT/DE2006/001712 filed Sep. 28, 2006 and claims the benefit thereof and is incorporated by reference herein in its entirety.

### FIELD OF INVENTION

The invention relates to a method for the wear-minimized operation of at least one installation component in an installation and to an installation having means for implementing said method.

### BACKGROUND OF INVENTION

A method of said type is employed in material processing installations and power stations in which rotating installation components, for example, such as centrifugal pumps, compressors, turbines, mills, centrifuges etc. are used. Wear that occurs during ongoing operation causes the components to become degraded to the possible extent of suffering total functional failure that may even result in an enforced standstill of the installation. They therefore have to be maintained at regular intervals. The maintenance intervals must be selected as sufficiently short to as far as possible precludes an unexpected outage. The maintenance intervals can be lengthened by operating the components as gently as possible, which means choosing an operating mode (while at the same time adhering to specified boundary conditions) that will minimize wear. Operating conditions that cause high wear can arise when, for instance, a component is operated at its resonant frequency. The strong vibrations can cause it to age very quickly.

Present-day practice where critical units are concerned is to attempt to minimize maintenance expenditure—without sacrificing availability—by adopting condition-oriented or predictive maintenance strategies (see in this connection EP 1 442 339 B1, for example). Minimizing here means lengthening the maintenance intervals. The additionally required sensors for condition recognition (for example vibration sensors) are employed only for monitoring in order to schedule maintenance measures and, where applicable, to initiate emergency shutdown (protective function). The sensor signals can be evaluated by a diagnostic device or directly in the process control system. The component's standard process control means, for example its rotational speed controller, load controller, and suchlike, operates together with the assigned standard sensor (for example a rotational speed sensor) but does not at present utilize the additional information from, for instance, a diagnostic field device, which is to say the evaluation of the sensor signals of the sensor for condition recognition.

DE 102 54 819 A1 discloses a method for monitoring at least one hydraulic component in a motor vehicle, wherein for monitoring purposes at least one measurement of the wear-inducing loading of the monitored component is provided together with a comparison of the measured loading with at least one predefinable threshold value, and wherein predefinable measures, in particular for reducing wear-inducing loadings, are initiated as a function of the comparison.

### SUMMARY OF INVENTION

An object of the invention is to disclose a method for the wear-minimized operation of components in an installation.

A further object of the invention is to disclose an installation having means for the wear-minimized operation of its components.

The object is achieved by a method as claimed in the claims.

The further object is achieved by an installation as claimed in the claims.

The components are usually operated within their high-load range to achieve as high as possible a throughput. If high-wear operating conditions (vibrating, for example) occur on a component, they will be recognized by the existing or, where applicable, newly added sensors and the associated evaluation (“diagnostic field devices”) and, for example, forwarded to a process control system. Here there is a function that supplements and is superimposed upon the existing automated process: What is termed a SmO (“Stress-minimized Operation of components”) function. It utilizes the additional information during ongoing operation and intervenes in the conventional automated process (regulating/controlling) so that high-wear operating conditions will be reduced or avoided by optimal process management. If, for example, a component is being operated at its resonant frequency, the SmO function will ensure that it is operated at a slightly different rotational speed at which far less strong vibrations occur. That method will hence extend the useful life of installation components and allow an installation's capacity to be optimally utilized while protecting the installation components. That is a totally novel approach for lengthening an installation component's maintenance intervals by the skillful use of information from diagnostic field devices (or existing sensors) for process management. That improvement to process management can be realized without any additional hardware if a process control system is present in any event and a diagnostic field device is installed to provide a protective function.

In an advantageous variant of the embodiment a first threshold value for the sensor signal is set on the exceeding of which the change in the at least one installation component's operating condition will be activated. Said threshold value can therein either have been pre-set on an installation-specific basis or be defined by a user. What is achieved thereby is that the SmO function will not immediately intervene in the installation component's operation when just minor changes take place but only when a wear-inducing operating condition occurs that is relevant to degradation. That can be done by the process control system itself when the tolerance threshold, which is to say the settable threshold value, is exceeded. An override (replacement) controller could alternatively also be used, in which case the normal main controller will be replaced by a “wear controller” as soon as a specific wear threshold is exceeded. Since, though, only one actuating intervention is available for both controllers it means that either the main controller or the wear controller will be given access to the actuator. The main controlled variable will be totally ignored once the wear controller has assumed control, and will continue being ignored until the wear controller has succeeded in sufficiently reducing the wear. The above-cited finely-tuned compromising will not be possible owing to the hard switchover.

In another advantageous embodiment variant a second threshold value for the sensor signal is set on the exceeding of which a protective function for the at least one installation component will be activated. That threshold value, too, can therein either have been pre-set on an installation-specific basis or be defined by a user. What is achieved thereby is that the protective function or, as the case may be, maintenance strategy usually in place in any event will come into play as hitherto.

In another advantageous embodiment variant, if there is a coupling between the at least one installation component and at least one other installation component, then the operating condition of the at least one other, coupled installation component will also be changed in a coordinated manner if the operating condition of the at least one installation component is changed. That ensures that the SmO function will also intervene in higher-order controlling in the case of coupled components such as, for instance, two pumps that convey different substances for mixing them, and change the rotational speed of both pumps in a coordinated manner. The resulting product will thus remain the same in quality.

In another advantageous embodiment variant, if a wear-inducing operating condition has occurred, the change in the at least one installation component's operating condition will be limited by at least one process management objective. The process control system can in that way control the installation component's operation in such a way that a kind of compromise will be achieved between the pre-specified objectives of process management and the objective of minimizing wear on the relevant installation component, meaning that the SmO function will intervene only within expedient limits.

In another advantageous embodiment variant, for influencing the change in the operating condition, priorities and/or weightings for the change and for the at least one process management objective are therein specified by a user. The choice of compromise can thereby be influenced by the user.

In another advantageous embodiment variant, a model-based predictive multiple-variable controller is used for influencing the change—due to the at least one process management objective—in the at least one installation component's operating condition. An algorithm of such kind is an obvious choice for handling different, mutually competing control objectives. It is able to minimize a quadratic quality criterion over a certain time horizon in the future. Future deviations in the main controlled variable and the necessary changes in the manipulated variables have hitherto been taken into account in the quality criterion. If a measure of the intensity of wear is now additionally known (for example from the vibration amplitude), it can be used as a further controlled variable. A suitable desired value (typically zero) is for that purpose established having a tolerance band, meaning that the controller will only take said auxiliary controlled variable into account if it rises above a certain tolerance threshold. The quality criterion for the predictive controller is expanded to include a third summand and so assumes the following form:

J=Σ(wᵢ−yᵢ)²+λΣΔuᵢ²+λᵥΣ(wᵥᵢ−yᵥᵢ)²→min.

yᵥᵢ is a measure of the wear at the instant i, wᵥᵢ is the desired value of the wear (typically zero), and λᵥ is the weighting for the wear compared with the main controlled variable. (The tolerance band is not taken into account in the formula. In fact the actual value's deviation from the tolerance band instead of from the exact desired value is determined by way of a case differentiation.) As a prerequisite for that, an experiment is necessary to identify what impact changing the manipulated variable (the rotational speed, for example) has on the intensity of wear (vibration amplitude, for example). That inventive approach enables the SmO function to be realized in process control systems with the aid of a serially produced predictive controller.

### BRIEF DESCRIPTION OF THE DRAWING

The invention is described and explained in more detail below with the aid of the exemplary embodiment shown in the FIGURE.

### DETAILED DESCRIPTION OF INVENTION

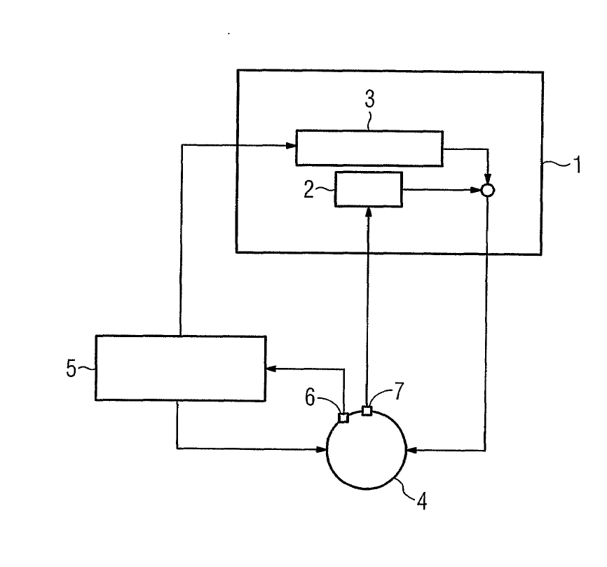

FIG. 1 shows an exemplary control loop in an installation having a process control system 1 and an installation component 4 which in this instance is embodied as a centrifugal pump. The process control system 1 has a controller 2 and an SmO function 3 which, when a wear-inducing operating condition of the centrifugal pump 4 occurs, can intervene in process management in such a way that a less wear-inducing operating condition will be achieved. The centrifugal pump 4 is taken via a rate regulator 2 to a specific rotational speed that is measured via a standard sensor: The rotational speed sensor 7. Cavitation on the rotor blades reduces the efficiency of the pump 4 and erodes the blades. Said Cavitation can be registered by a structure-borne noise sensor 6 or quantified by means of the conditions causing it (pressure, temperature, material properties). The sensor signal of the structure-borne noise sensor 6 is checked by an evaluation unit 5 to determine the presence of a wear-inducing operating condition. If an undesirable degree of cavitation then occurs at a certain rotational speed, the SmO function 3 will intervene in the operation of the rate regulator 2 to the effect that the rotational speed will be lowered until cavitation is reduced to a tolerable level. The rotational speed thus set will be a compromise between the rotational speed required by the rate regulator 2 and the rotational speed tolerated by the SmO function 3. Depending on the specific boundary conditions, virtually the desired flow rate can be achieved thanks to the improved efficiency even at a reduced rotational speed.

To summarize, the invention relates to a method for the wear-minimized operation of at least one installation component in an installation and to an installation having means for implementing said method. To enable the wear-minimized operation of components in an installation it is proposed for a sensor for condition recognition that is assigned to the installation component to convey a sensor signal to an evaluation unit, for the evaluation unit to check the sensor signal to determine the presence of a wear-inducing operating condition, and, if such an operating condition is present, for the corresponding installation component to be controlled such that the operating condition will be changed in favor of a less wear-inducing operating condition. If, for example, a component is being operated at its resonant frequency, it will be ensured that it will be operated at a slightly different rotational speed at which far less strong vibrations occur. That method will hence extend the useful life of installation components and allow an installation's capacity to be optimally utilized while protecting the installation components.

1.-12. (canceled)

13. A method for wear-minimized operation of a first installation component of an installation, comprising:
transmitting a sensor signal by a sensor to an evaluation unit for condition recognition, the sensor being assigned to the first installation component;
checking the sensor signal by the evaluation unit to determine the presence of a wear-inducing operating condition of the first installation component;
controlling the first installation component when the wear-inducing operation condition is present;
changing the wear-inducing operation condition of the first installation component to a less wear-inducing operating condition; and
changing in a coordinated manner an operating condition of a second installation component when there is a coupling between the first installation component and the second installation component and the operating condition of the first installation component is changed.

14. The method as claimed in claim 13, further comprising:
setting a first threshold value for the sensor signal; and
activating the changing of the operating condition of the first installation component when the first threshold value is exceeded.

15. The method as claimed in claim 13, further comprising:
setting a second threshold value for the sensor signal; and
activating a protective function for the first installation component when the second threshold value is exceeded.

16. The method as claimed in claim 14, further comprising:
setting a second threshold value for the sensor signal: and
activating a protective function for the first installation component when the second threshold value is exceeded.

17. The method as claimed in claim 13, wherein, when a wear-inducing operating condition has occurred, the changing of the operating condition of the first installation component is limited by a process management objective.

18. The method as claimed in claim 17, wherein, for influencing the changing of the operating condition, priorities or weightings for the changing and for the process management objective are specified by a user.

19. The method as claimed in claim 17, wherein, for influencing the changing of the operating condition, priorities and weightings for the changing and for the process management objective are specified by a user.

20. The method as claimed in claim 17, wherein, due to the process management objective, a model-based predictive multiple-variable controller is used for influencing the changing of the operating condition of the first installation component.

21. The method as claimed in claim 18, wherein, due to the process management objective, a model-based predictive multiple-variable controller is used for influencing the changing of the operating condition of the first installation component.

22. The method as claimed in claim 19, wherein, due to the process management objective, a model-based predictive multiple-variable controller is used for influencing the changing of the operating condition of the first installation component.

23. An installation unit, comprising:
a first installation component;
a second installation component;
a sensor assigned to the first installation component for recognizing a operating condition of the first installation component;
an evaluation unit for checking a sensor signal transmitted by the sensor for the presence of a wear-inducing operating condition affecting the first installation component;
a control unit for controlling the first installation component such that the wear-inducing operating condition is changed to a less wear-inducing operating condition when a wear-inducing operating condition is present; and
a coupling between the first and the second installation component,
wherein a operating condition of the second installation component is changed in a coordinated manner when the operating condition of the first installation component is changed.

24. The installation unit as claimed in claim 23, wherein a first threshold value for the sensor signal is set and the changing of the operating condition is activated by the control unit when the first threshold value is exceeded.

25. The installation unit as claimed in claim 23, wherein a second threshold value for the sensor signal is set and a protective function is activated when the second threshold value is exceeded.

26. The installation unit as claimed in claim 23, wherein a second threshold value for the sensor signal is set and a protective function is activated when the second threshold value is exceeded.

27. The installation unit as claimed in claim 24, wherein a second threshold value for the sensor signal is set and a protective function is activated when the second threshold value is exceeded.

28. The installation unit as claimed in one of claims 23, wherein the changing of the operating condition of the first installation component is limited by a process management objective when a wear-inducing operating condition has occurred.

29. The installation unit as claimed in claim 28, wherein, for influencing the changing of the operating condition, priorities or weightings for the changing and for the process management objective are specified by a user.

30. The installation unit as claimed in claim 28, wherein, for influencing the changing of the operating condition, priorities and weightings for the changing and for the process management objective are specified by a user.

31. The installation unit as claimed in claim 28, wherein, due to the process management objective, a model-based predictive multiple-variable controller is used for influencing the changing of the operating condition of the first installation component.

32. The installation unit as claimed in claim 29, wherein, due to the process management objective, a model-based predictive multiple-variable controller is used for influencing the changing of the operating condition of the first installation component.
